(19) United States
(12) Patent Application Publication
(10) Pub. No.: US 2008/0140459 A1
(43) Pub. Date: Jun. 12, 2008

(54) AUTOMATED SOLUTION FOR LOADING USER-ENTERED NAVIGATIONAL DATA INTO THE NAVIGATION SYSTEM OF A RENTAL VEHICLE

(75) Inventors: Akram A. Bou-Ghannam, Lake Worth, FL (US); Victor S. Moore, Lake City, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/608,053

(22) Filed: Dec. 7, 2006

(51) Int. Cl. G06Q 10/00

(52) U.S. Cl. 705/5; 705/1

(57) ABSTRACT

The present solution can include a method for automatically loading navigational information into a rental vehicle's navigation system. A rental agency's system can acquire navigational information from a user that is associated with a particular rental occurrence prior to a rental vehicle being assigned to that user's rental request. The navigational information can then be stored in a data store that can be accessed by rental agency's system. At some time after the collection of the navigational information for the rental occurrence, the rental agency can assign a rental vehicle to the user's rental occurrence. Once a rental vehicle is assigned, the navigational information can be loaded into the in-vehicle navigation system of the assigned rental vehicle.

### BACKGROUND

1. Field of the Invention

The present invention relates to the field of navigational information handling and, more particularly, an automated solution for loading user-centered navigational information into the navigation system of rental vehicle.

2. Description of the Related Art

In-vehicle navigation systems are useful tools for guiding people to a variety of destinations. The inclusion of such systems in rental vehicles is a practical feature for business people who travel extensively. While almost every in-vehicle navigation system has an interface for entering navigation information, these interfaces are typically difficult for an average user to utilize. Worse, interfaces are generally not standardized so that a user familiar with one in-vehicle navigation system may not know how to enter navigational information on a different in-vehicle navigation system. Moreover, a lack of robust peripheral interface devices for in-vehicle navigation systems typically make entry of navigational information a slow, cumbersome task. As a result, it is impractical to expect an average user of a rental vehicle to enter user useful navigational information into an in-vehicle navigation system.

Many teachings exist for allowing the loading of navigational information into an in-vehicle navigation system via an intermediary memory artifact, such as a smart card or magnetic strip card. This requires that the in-vehicle system contain a reader for the specific memory artifact. Additionally, proper use of the system requires that the user's information is not corrupted and that the user does not lose the memory artifact or attempt to load the information properly. Further, to make loading navigational information via a memory artifact practical in the context of rented vehicles containing navigation systems, rental vehicles would have to be standardized to accept a common artifact and data format, which is not the case. Instead, most conventional in-vehicle navigation systems lack a convenient reader for a memory artifact and use proprietary formats for navigational information that are incompatible with other navigation systems.

In an attempt to address these pitfalls, some rental agencies have attempted to load navigational information for a user when a vehicle is picked up from a facility. This practice requires the user to provide the navigational information verbally to a rental agent, who then transfers the data to the in-vehicle system. While this eliminates problems of data corruption and improper usage, it is burdensome to a frequent traveler. It is also subject to transcription errors and is manpower intensive, which often minimally staffed rental agencies can ill afford. Additionally, the provided navigational information is not retained for future use requiring the user repeat their navigational information every time a vehicle is rented which can become tiresome for all involved.

### SUMMARY OF THE INVENTION

The present invention provides a solution for loading user specific information into in-vehicle navigation systems of rented vehicles. When a user rents a vehicle, such as through a rental agency's Web site, the user can specify navigational information that is to be loaded into a rented vehicle. The navigational information can be stored in the car agency's computer system, along with the rental information. It should be appreciated that vehicles are not generally assigned when a reservation is made, but instead are assigned much later, often only after a person arrives for a vehicle at the rental agency location. No known existing vehicle reservation system stores customer specific navigational information that is able to be loaded into in-vehicle navigation systems. Whenever a vehicle is assigned to the user, the navigational information can be automatically loaded into the in-vehicle navigation system of the assigned vehicle. The loading of navigational information can be performed as part of a car preparation process. In one embodiment, the rental agency can store the navigational information so that it is available to the user in the future.

The present invention can be implemented in accordance with numerous aspects consistent with material presented herein. For example, the present solution can include a method for automatically loading navigational information into a rental vehicle's navigation system. A rental agency's system can acquire navigational information from a user that is associated with a particular rental occurrence prior to a rental vehicle being assigned to that user's rental occurrence. The navigational information can then be stored in a data store that can be accessed by a rental agency's system. At some time after the collection of the navigational information for the rental occurrence, the rental agency can assign a rental vehicle to the user's rental occurrence. Once a rental vehicle is assigned, the navigational information can be loaded into the in-vehicle navigation system of the assigned rental vehicle.

Another aspect of the present invention can include a system for automatically loading user-entered navigational information into the navigation system of a rental vehicle. The system can include the rental agency's reservation system, a navigational information data store, a network, and multiple in-vehicle navigation systems. The reservation system can be configured to assign vehicles to customers for different rental occurrences and to access the navigational information data store Additionally, the navigational information store can be configured to store navigational information for multiple rental occurrences prior to a rental vehicle being assigned to the rental occurrences. The network can be configured to connect the reservation system to the multitude of in-vehicle navigation systems and the navigational information store.

Yet another aspect of the present invention can include a Web site where a user can specify navigational information to be entered into the navigation system of a yet-to-be-assigned rental vehicle. The Web site can include an interface in which the user can specify navigational information for an existing rental occurrence prior to the assignation of a rental vehicle for the specified rental occurrence. Additionally, the Web site can include an association control in which the user associates navigational information with a specific rental occurrence, so that the associated navigational information can be automatically transferred to an in-vehicle navigation system once a rental vehicle is assigned to the specific rental occurrence.

It should be noted that various aspects of the invention can be implemented as a program for controlling computing equipment to implement the functions described herein, or a program for enabling computing equipment to perform processes corresponding to the steps disclosed herein. This program may be provided by storing the program in a magnetic disk, an optical disk, a semiconductor memory, any other recording medium, or can also be provided as a digitally encoded signal conveyed via carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a server agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for providing the automatic loading of navigational information into an in-vehicle navigation system in accordance with embodiments of the inventive arrangements disclosed herein.

FIG. 2 is a schematic diagram illustrating a Web page in which a user can enter navigational information for automatic loading into the navigation system of a rental vehicle in accordance with an embodiment of the inventive arrangements disclosed herein.

FIG. 3 is a flow chart of a method for automatically loading user-entered navigational information into an in-vehicle navigation system in accordance with an embodiment of the inventive arrangements disclosed herein.

FIG. 4 is a flow chart of a method where a service agent can configure a system to perform the automatic loading of user-entered navigational information into the navigation system of a rental vehicle in accordance with an embodiment of the inventive arrangements disclosed herein.

### DETAILED DESCRIPTION OF THE INVENTION

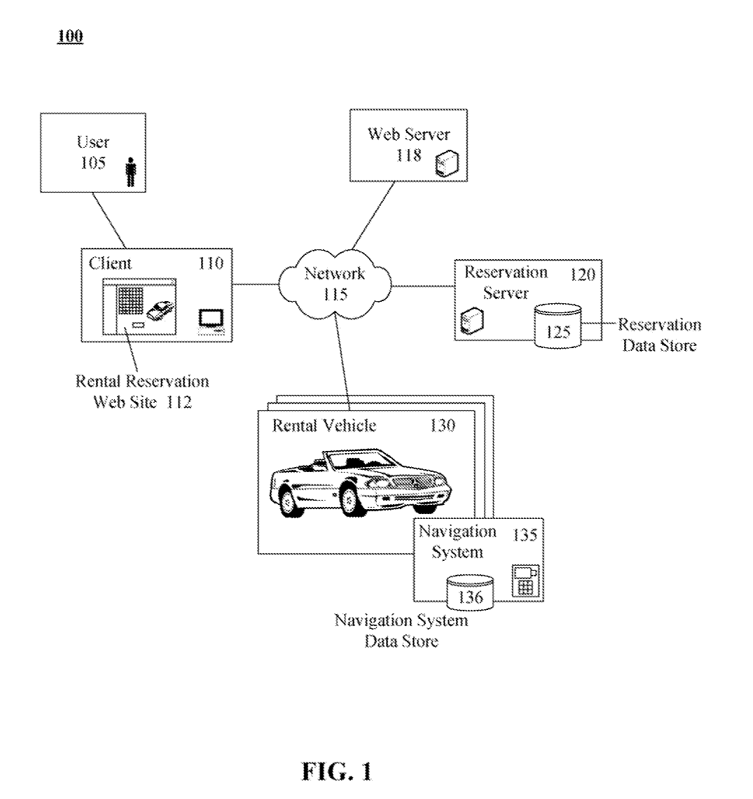

FIG. 1 is a schematic diagram illustrating a system 100 for providing the automatic loading of navigational information into an in-vehicle navigation system 135 in accordance with embodiments of the inventive arrangements disclosed herein. The navigational information that user 105 desires to be loaded into an in-vehicle navigation system 135 can be entered into a rental reservation Web site 112 accessed on a client 110 machine.

The rental reservation Web site 112 can be developed and maintained on a Web server 118 separate from the reservation server 120. Additionally, the Web server 118 can be maintained by a third party that is separate from the rental vehicle agency. For example, the rental agency can contact a Web hosting company to host the Web pages associated with the rental reservation Web site 112. In another example, the navigational information service for acquiring user-defined navigational information can be a Web service available to users 105 that is integrated with systems of one of more rental agencies. For instance, the navigational information can be automatically acquired from a travel agency system that includes trip itinerary information. The travel agency system can send the navigational information to the reservation system 120, when the itinerary includes a vehicle rental.

In another embodiment (not shown), the Web server 118 can be a component of the rental agency's enterprise network. In such an embodiment, an enterprise network can exist that communicatively links the Web server 118, the reservation server 120, and the navigation systems 135 of the rental vehicles 130. This enterprise network would be connected to network 115 in order to receive data entered by a user 105 into the pages of the rental reservation Web site 112.

The rental reservation Web site 112 can contain Web pages in which the user 105 can enter navigational information that can be downloaded into the navigation system data store 136 of the navigation system 135 once a rental vehicle 130 is assigned to the rental occurrence. Until that time, the navigational information can be stored in data store 125. In addition to entering navigational information, a user 105 can make a rental reservation through the reservation rental Web site 112. However, the invention is not limited as such, and a user 105 can make a reservation through other means, such as over a land-based or wireless phone, in-person at a physical location of the rental agency, over a phone using an interactive voice response (IVR) system, and the like.

At a point after the user 105 saves the navigational information and associates it with a specific rental occurrence, a rental vehicle 130 can be assigned to the rental occurrence. The assignation of a rental vehicle 130 to a rental occurrence can be performed by an algorithm within the rental agency's reservation system 120 or can be performed manually by a human agent. Once the assignation occurs, the navigational information can be automatically loaded over the network 115 into the navigation system data store 136 of the assigned rental vehicle 130.

As used herein, presented data stores, including stores 125 and 136, can be a physical or virtual storage space configured to store digital information. Data stores 125 and 136 can be physically implemented within any type of hardware including, but not limited to, a magnetic disk, an optical disk, a semiconductor memory, a digitally encoded plastic memory, a holographic memory, or any other recording medium. Each of the data stores 125 and 136 can be a stand-alone storage unit as well as a storage unit formed from a plurality of physical devices. Additionally, information can be stored within data store 125 and 136 in a variety of manners. For example, information can be stored within a database structure or can be stored within one or more files of a file storage system, where each file may or may not be indexed for information searching purposes. Further, data stores 125 and/or 136 can utilize one or more encryption mechanisms to protect stored information from unauthorized access.

Network 115 can include any hardware/software/and firmware necessary to convey data encoded within carrier waves. Data can be contained within analog or digital signals and conveyed through data or voice channels. Network 115 can include local components and data pathways necessary for communications to be exchanged among computing device components and between integrated device components and peripheral devices. Network 115 can also include network equipment, such as routers, data lines, hubs, and intermediary servers which together from a data network, such as the Internet. Network 115 can also include circuit-based communication components and mobile communication components, such as telephone switches, modems, cellular communication towers, and the like. Network 115 can include line based and/or wireless communication pathways.

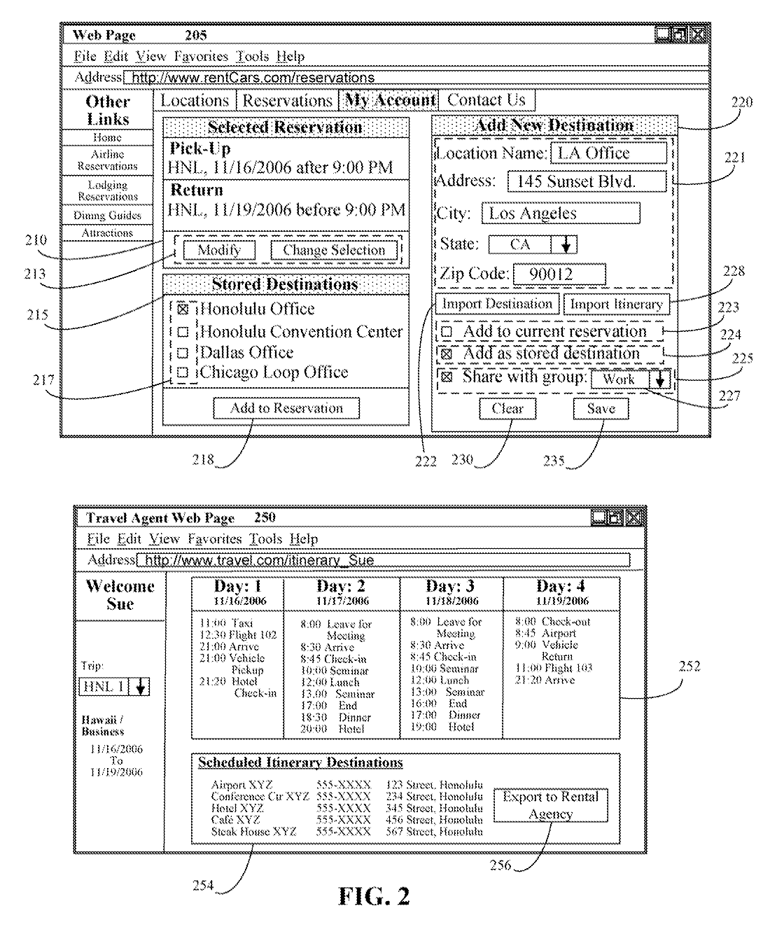

FIG. 2 is a schematic diagram illustrating a Web page 205 in which a user can enter navigational information for automatic loading into the navigation system of a rental vehicle in accordance with an embodiment of the inventive arrangements disclosed herein. This Web page 205 can be an element of the rental reservation Web site 112 of system 100. The Web page 205 is not limited in this regard, however, and can be implemented as an element of a Web site in the context of any system supporting the automatic loading of Web-entered navigational information into the navigation system of a rental vehicle. Accordingly, the components illustrated in the Web page 205 can be implemented in any type of manner consistent with Web-enabled data collection and transmission. It should be appreciated that the components illustrated in this Web page 205 are meant to illustrate the functionality of the invention and are not meant as comprehensive or limiting.

The components of the Web page 205 can include a selected reservation display 210, a stored destination display 215, and a destination entry section 220. The rental occurrence for which a user desires to enter and/or associate navigational information with can be selected by a user and then displayed in the selected reservation display 210. In this example, the user has selected a reservation occurrence for a trip to Honolulu, Hi. The selected reservation display can include action buttons 213 by which a user can perform designated actions. Buttons to allow a user to modify the selected reservation and select a different reservation are shown in this illustration.

In order to increase data reusability, a user can store their entered navigational information for future use. This functionality can eliminate the need for repetitive entry or communication by users and can increase the efficiency of the overall rental process. Navigational information that was previously entered and stored by the user can be presented within the Web page 205 in the stored destination display 215. Additionally, this listing can be further narrowed to navigational information that is in the vicinity of the selected reservation. For example, since the user selected a reservation for Honolulu, the list shown in the stored destination display 215 could be restricted to only stored navigational information for Hawaii and would only display the items Honolulu Office and Honolulu Convention Center.

The stored destinations display 215 can include a set of destination selectors 217 and an add button 218. The set of destination selectors 217 can be a Web control that allows a user to designate navigational information that they want loaded into the in-vehicle navigation system. A destination selector 217 should exist for each destination listed within the stored destinations display 215. Once stored destinations are selected, which are indicated by “checked” boxes in this example, the user can associate the navigational information corresponding to the selected destinations to the selected reservation by clicking the add buttons 218. Further, the stored destinations display 215 can present a user with a visual indication of the navigational information currently associated with an existing reservation.

The disassociation of an already selected destination can be achieved in a variety of manners. It should be appreciated that the actual method implemented depends upon the actual implementation of the Web page 205 and its components as well as the underlying infrastructure. For example, the undesired destination an be unchecked and the remaining set of selected destinations re-associated with the reservation, with the “new” set of destinations overwriting the old set. Likewise, the set of unselecting the destination can trigger a script that automatically disassociates the navigational information of the destination with the reservation.

The destination entry section 220 can allow a user to enter navigational information that can be stored and/or loaded into the in-vehicle navigation system of a rental vehicle. Navigational information can be entered manually by a user in the destination data fields 221 or electronically imported from another source via the import button 222. The destination data fields 221 can include areas for a user to enter the navigational information necessary for proper use by the in-vehicle navigation system and can include any of a variety of controls to ensure accurate data entry. In this example, the destination data fields 221 simply correspond to an address of a physical location and include a field, called Location Name, for the user to label the destination; the contents Location Name field are displayed in the stored destination display 215.

The import button 222 can allow the user to load navigational information from other sources, such as a personal in-vehicle navigation system, an appropriate file stored on the user's client device, a third-party mapping application, and the like. Use of this option can incur the need for adding an additional component to the system to test the compatibility of the imported data with the format required for the in-vehicle navigation system. However, this option can eliminate data entry errors in the destination data fields 221, which can result in incorrect navigational information being loaded into the in-vehicle navigation system. In one embodiment, a button 228 can be used for a special import case, where the navigational information is obtained from a travel itinerary, which is illustrated in GUI 250.

Once the navigational information for a destination is entered or imported, the user can select one or more actions to perform with the information. The actions illustrated in this example are add to reservation 223, store destination 224, and share destination 225. Any action or actions selected, which are indicated by “checked” boxes in this example, can be executed by the system when the user selects the save button 235.

The add to reservation 223 action can associate the provided navigational information with the selected reservation. The store destination 224 can store the provided navigational information for future use. Selection of this action can then result with the navigational information appearing in the list contained within the stored destination display 215.

The share destination 225 action can make the provided navigational information available to other users of the reservation system. The group of users to share the navigational information with can be denoted with the group selector 227. In this example, the group selector 227 is illustrated as a drop-down list, but it can be any type of Web-enabled selection mechanism usable within the system. User groups for selection can be defined in another Web page or Web page component (not shown).

GUI 250 shows a travel agent Web page 250, which includes itinerary information. This information can include a schedule 252 and a list of destinations 254 associated with the schedule 252. Each destination in the list 254 can include a contact phone number, and a destination address. As shown, destinations can include an airport, a conference center, a hotel, a cafe (associated with dinner on Day 2 of schedule 252), and a steak house (associated with dinner on Day 3 of schedule 252). Button 256 can export itinerary information and destination to a vehicle rental system, which is associated with the vehicle pickup and drop off events of schedule 252. Button 256 can provide equivalent results of button 228, except that data is pushed to a rental agency's system instead of pulled into the rental agency system. In one embodiment, the pushed navigational information can include navigational information about destination in list 254 as well as itinerary information from schedule 254. Accordingly, when a traveler associated with the itinerary of page 250 picks up the rental vehicle, the in-vehicle navigation system can be automatically “pre-loaded” with the traveler's schedule and travel destination.

It should be appreciated that GUI 250 illustrates generally how travel-related information in one computing system can be automatically conveyed to a rental agency system, so that it is available within an in-vehicle system of a rented vehicle at a time the rental vehicle is used. The invention is not limited to integration between a travel agency system and a rental system, and any of a variety of systems can be automatically integrated to the same effect. For example, a calendaring system associated with trip planning can be integrated. One advantage of integrating these systems is that navigational information for a rental vehicle can be automatically updated as travel arrangement, engagement locations, and the like change.

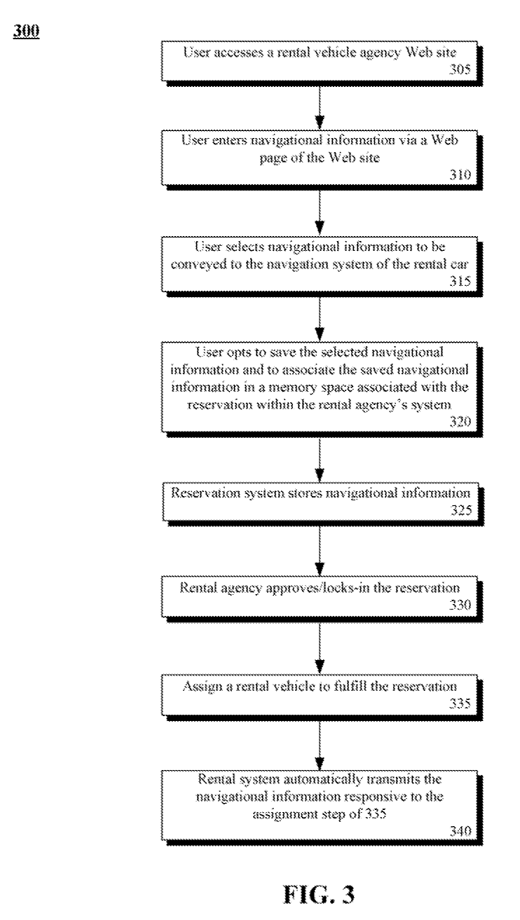

FIG. 3 is a flow chart of a method 300 for automatically loading user-entered navigational information into an in-vehicle navigation system in accordance with an embodiment of the inventive arrangements disclosed herein. Method 300 can be performed in the context of system 100 or in the context of any other system supporting automatic loading of Web-entered navigational information into the navigation system of a rental vehicle.

Method 300 can begin with step 305 where a user accesses the Web site of a rental vehicle agency. In step 310, the user can enter navigational information into a properly configured Web page of the Web site, such as Web page 305. Next, the user can select the navigational information that is to be conveyed to the in-vehicle navigation system in step 315.

In step 320, the user can opt to save the selected navigational information and associate the navigational information with an existing reservation that is already stored within the rental agency's system. The selected navigational information can also include navigational information previously stored by the user and presented in the accessed Web page as well as information imported by the user from a source external to the Web site.

The existing reservation could have been created in a variety of manners, including, but not limited to, a previous visit to the rental agency's Web site, a phone call to reservation agent of the rental agency, through interaction with an IVR system of the rental agency, and the like. Additionally, the user performing the so-noted steps of method 300 can be a representative of a corporate identity or account.

Regardless of the origin of the selected navigational information, the reservation system can store the navigational information in step 325. The physical storage associated with this step can be owned and maintained by the rental agency or contracted from a third party that can be accessed by the agency's reservation system. The storing of the navigational information can include additional data that indicates the navigational information is affiliated with the specified reservation and/or user.

In step 330, the rental agency can approve the reservation. A rental vehicle can be assigned to the reservation in step 335. It should be appreciated that this step can occur at any point after the reservation approval up until the actual pick-up of the vehicle by the user. It should also be appreciated that until the execution of this step in the method, the rental vehicle has existed as an intangible object. That is, the user may have specified a type of vehicle preferred, such as “Luxury” or “Mid-Sized”, but the availability of vehicles at the rental agency is generally unknown until a time much closer to that of the reservation; the reservation is assigned a vehicle from those available on premise. This can result in the user receiving a rental vehicle that is not of the type requested in the reservation. Additionally, a user can present an agent of the rental agency with a coupon to upgrade the type of rental vehicle when picking up the vehicle.

Step 340 occurs in response to the assignation of a vehicle to the reservation in step 335. In step 340, the rental agency's system automatically transmits the navigational information associated with the reservation to the in-vehicle navigation system of the assigned rental vehicle. It should be appreciated that step 340 can be performed prior to a user arriving at the rental agency to pick up the rental vehicle. Thus, the rental vehicle can be prepared and waiting for the user.

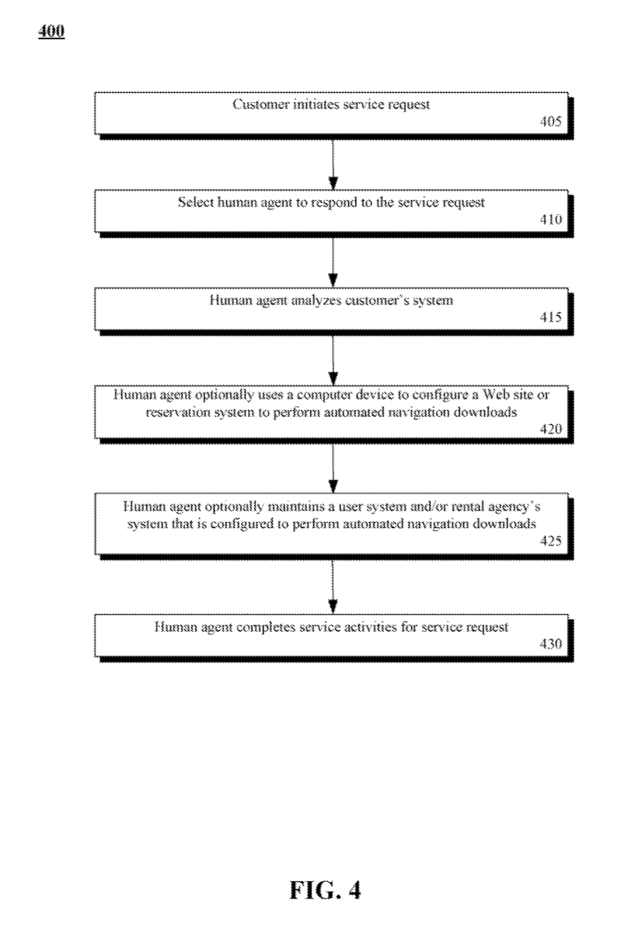

FIG. 4 is a flow chart of a method 400 where a service agent can configure a system to perform the automatic loading of user-entered navigational information into the navigation system of a rental vehicle in accordance with an embodiment of the inventive arrangements disclosed herein. Method 400 can be performed in the context of system 100 and/or method 300.

Method 400 can begin in step 405, when a customer initiates a service request. The service request can be a request for a service agent to integrate Web site acquired navigational information into a rental agency's system. The service request can also be a request to automate a vehicle check-out process so that navigational information is automatically loaded into the in-vehicle navigation systems.

In step 410, a human agent can be selected to respond to the service request. In step 415, the human agent can analyze a customer's current system and can develop a solution. The solution can result in system 100 or any system that can be configured to perform automatic loading of navigational information into the navigation systems of rental vehicles, such as a system that performs the steps of method 300.

In step 420, the human agent can configure the customer's system to load navigational information into the navigation systems of rental vehicles in an automatic fashion. This can include the development of a Web site to capture and display navigational information, and the configuration of memory space to store the navigational information. In step 425, the human agent can optionally maintain such a Web site or system for the customer. The human agent can perform steps 420 and 425 and/or can configure a computing device of the customer in a manner that the customer or clients of the customer can perform steps 420 and 425 using the configured system in the future. For example, the service agent can create Web pages and controls for the capture and display of navigational information which can then be maintained and updated by the customer. In step 430, the human agent can complete the service activities.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

What is claimed is:

1. A method for placing navigational information into rental vehicle navigation systems comprising:
before assigning a rental vehicle to a user, acquiring navigational information from the user that is associated with a particular rental occurrence;
storing the navigational information in a rental vehicle agency accessible data store;
assigning a rental vehicle to the user for the rental occurrence; and
responsive to the assigning step, loading the navigational information into an in-vehicle navigation system of the assigned rental vehicle.

2. The method of claim 1, further comprising:
providing a Web site to users through which a user is able to enter navigational information; and
receiving the navigational information via the Web site.

3. The method of claim 2, wherein the Web site is a site through which users are able to rent vehicles, said method further comprising:
receiving a vehicle reservation request for the rental occurrence along with the navigational information via the Web site.

4. The method of claim 2, wherein the Web site is operated by a third party not directly controlled by a rental vehicle agency that provides the assigned rental vehicle.

5. The method of claim 1, further comprising:
maintaining the navigational information in the data store after the rental occurrence is completed, wherein the navigational information is available for future rental occurrences.

6. The method of claim 5, further comprising:
providing a Web site to users through which a user is able to enter navigational information;
the Web site including a pick-up location for the rental occurrence;
searching the data store for historically entered navigational information associated with the user proximate to the pick-up location; and
presenting a list of navigational points included in the historically entered navigational information resulting from the searching step, wherein the acquired navigational information includes user selected ones of the navigational points.

7. The method of claim 1, wherein the loading step is automatically performed by an algorithm of a rental reservation application without intervention by a human agent of the rental vehicle agency.

8. The method of claim 1, wherein a computer system of the rental vehicle agency is communicatively linked to the in-vehicle navigation system via a network; said loading step further comprising:
the computer system loading the navigational information via the network as part of a vehicle preparation process.

9. The method of claim 1, wherein said steps of claim 1 are performed by at least one machine in accordance with at least one computer program having a plurality of code sections that are executable by the at least one machine.

10. The method of claim 1, wherein the steps of claim 1 are performed by at least one of a service agent and a computing device manipulated by the service agents, the steps being performed in response to a service request.

11. A system for providing the automatic loading of user-entered navigational information into the navigation system of a rental vehicle comprising:
a rental vehicle agency's reservation system configured to assign vehicles to customers for different rental occurrences;
a navigational information data store accessible by the reservation system that is configured to store navigational information for a plurality of rental occurrences, wherein said navigational information is stored in the data store before rental vehicles are assigned to the rental occurrences;
a network connecting the reservation system to a plurality of in-vehicle navigation systems; and
the plurality of in-vehicle navigation systems, each configured to be loaded with navigational information from the data store for specific rental occurrences via the network responsive to a command from the reservation system and subsequent to the reservation system assigning a vehicle for specific rental occurrences, wherein the assigned vehicle is a vehicle containing the in-vehicle navigation system that is loaded for a rental occurrence to which the vehicle is assigned.

12. The system of claim 11, wherein the rental vehicle agency's reservation system further comprises:
a Web site interface configured to accept navigational information from a user, wherein the navigational information entered through the Web site interface is stored within the navigational information data store.

13. The system of claim 12, wherein the Web site interface presents a user with a list of previously stored navigational information entries for selection.

14. The system of claim 12, wherein the Web site interface allows a user to create a reservation occurrence.

15. The of claim 12, wherein the web site interface is operated by a third party not directly controlled by a rental vehicle agency.

16. A Web site for specifying navigational information to be entered into yet-to-be-assigned rental vehicles comprising:
an interface in which a user specifies navigational information for an existing rental occurrence, wherein the navigational information is centered prior to the user being assigned a rental vehicle for the specified rental occurrence; and
an association control in which the user associates navigational information with the specified rental occurrence, wherein the associated navigational information is automatically transferred to an in-vehicle navigation system via a network after a rental vehicle is assigned to the specific rental occurrence.

17. The Web site of claim 16, wherein the interface and association control is an element of a rental vehicle's reservation system.

18. The Web site of claim 16, wherein the interface prompts the user to save entered navigational information for future rental occurrences.

19. The Web site of claim 16, wherein the interface allows the user to import navigational information from a user-defined external source.

20. The Web site of claim 16, further comprising:
a sharing control that allows the user to share the entered navigational information with a predefined group of users.
